(19) United States
(12) Patent Application Publication
(10) Pub. No.: US 2018/0364558 A1
(43) Pub. Date: Dec. 20, 2018

(54) PHOTO ASSISTANT DEVICE

(71) Applicant: VRVAORIGIN VISION TECHNOLOGY CORP. LTD., Taipei City (TW)

(72) Inventor: Hsin-Yang CHEN, Taipei City (TW)

(21) Appl. No.: 15/705,155

(22) Filed: Sep. 14, 2017

(30) Foreign Application Priority Data
Jun. 16, 2017 (TW) 106208762

(51) Int. Cl. G03B 35/04; G03B 17/14; G02B 17/06

(52) U.S. Cl. CPC G03B 35/04; G03B 9/08; G02B 17/06; G03B 17/14

(57) ABSTRACT

Disclosed is a photo assistant device detachably affixing to a photo device. The photo assistant device includes in a housing, a first reflector, a second reflector, an intermediate reflecting module, and a switch device. By means of the switch device, light incident into the photo assistant device from the outside can reach the lens of the photo device either via the first reflector and then the intermediate reflecting module or via the second reflector and then the intermediate reflecting module. As a result, the photo device with only one lens can take pictures as if being in different horizontal positions, without being actually moved horizontally.

This application is based on and claims the benefit of priority from Taiwan Patent Application 106208762, filed on Jun. 16, 2017.

### BACKGROUND OF THE INVENTION

### Field of the Invention

The present invention relates to photo-taking assistant devices and, more particularly, to a photo-taking assistant device unfastenably mounted on a photo-taking device to assist a user in taking 3D photos and shooting movies.

### Description of the Prior Art

Conventional mobile devices equipped with photo-taking lenses have become the most popular photo-taking device. Digital photos thus taken and movies thus shot can be readily shared and edited for future use.

In 2011, HTC launched EVO 3D, whereas LG launched Optimus 3D, both equipped with two 5-megapixel camera modules on the same side to take 3D photos and shoot movies in a full and complete manner. The 3D images thus produced are directly displayed on a screen, thereby dispensing with the need for a 3D display unit.

Although the conventional mobile devices and photo-taking devices can be equipped with two lenses on the same side, the majority have only one lens which is movable in order to take multiple 3D photos and then produce 3D images by software. For details of the aforesaid technical issue and solutions employed in the prior art, see US Pub. US20040213560A1.

Another design is embodied in Google's Jump cameras and Nokia's OZO cameras with lenses arranged to take stereoscopic photos at a viewing angle of 360°, wherein images captured by each lens undergo computer-generated imagery to create 3D images which visualize depth of field.

### SUMMARY OF THE INVENTION

The present invention provides a photo-taking assistant device unfastenably mounted on a photo-taking device to simulate taking multiple photos from different locations aligned transversely without moving the lens of the photo-taking device, thereby producing 3D images. Compared with conventional dual-lens photo-taking devices, the photo-taking assistant device of the present invention enhances flexibility of use. In particular, the photo-taking assistant device of the present invention is not only lightweight and convenient, but also incurs low cost, thereby allowing conventional photo-taking devices to be applied easily to 3D photo-taking and even allowing users to effectuate 3D photo-taking by cutting cardboards at home, as disclosed by Google Cupboard. Therefore, users can take photos and produce high-resolution 3D images easily, provided that the users are in possession of a high-resolution photo-taking device (for example, an advanced smartphone) and the photo-taking assistant device of the present invention, thereby dispensing with the need for expensive Google's Jump cameras and Nokia's OZO cameras.

The description below shows that the photo-taking assistant device of the present invention can not only be easily effectuated, for example, by making a casing from a cardboard and performing mechanical switching by hand, but also can be applied to advanced industrialized products with a view to achieving fully automated quick switching and reducing vibration.

In a first embodiment, a photo-taking assistant device unfastenably mounted on a photo-taking device, the photo-taking device comprising a lens, and the photo-taking assistant device includes:
a housing having a front side and a back side opposing the front side, the front side having a front opening for abutting against the photo-taking device so as to receive the lens, and the back side having at least one back opening for admitting an incident external light beam to the housing;
a first reflector disposed in the housing to reflect the external light beam off the first reflector;
a second reflector disposed in the housing to reflect the external light beam off the second reflector;
an intermediate reflecting module disposed in the housing to reflect the external light beam reflected off the first reflector so that the external light beam falls on the lens or reflect the external light beam reflected off the second reflector so that the external light beam falls on the lens; and
a switcher,
wherein the photo-taking assistant device switches between a first state and a second state by the switcher,
wherein the switcher ensures that substantially no external light beam reaches the lens via the first reflector and the intermediate reflecting module when the photo-taking assistant device is in the first state and that substantially no external light beam reaches the lens via the second reflector and the intermediate reflecting module when the photo-taking assistant device is in the second state.

In a second embodiment, a photo-taking assistant device unfastenably mounted on a photo-taking device, the photo-taking device comprising a lens, and the photo-taking assistant device includes:
a housing having a front side and a back side opposing the front side, the front side having a front opening for abutting against the photo-taking device so as to receive the lens, and the back side having at least one back opening for admitting an incident external light beam to the housing;
a first reflector disposed in the housing to reflect the external light beam off the first reflector;
an intermediate reflecting module disposed in the housing to reflect the external light beam reflected off the first reflector so that the external light beam falls on the lens so that the external light beam falls on the lens; and
a switcher,
wherein the photo-taking assistant device switches between a first state and a second state by the switcher,
wherein the switcher ensures that substantially no external light beam reaches the lens via the first reflector and the intermediate reflecting module when the photo-taking assistant device is in the first state and that substantially the external light beam reaches the lens via the first reflector and the intermediate reflecting module when the photo-taking assistant device is in the second state.

In a third embodiment, a photo-taking assistant device unfastenably mounted on a photo-taking device, the photo-taking device comprising a lens, and the photo-taking assistant device includes:
a housing having a front side and a back side opposing the front side, the front side having a front opening for abutting against the photo-taking device so as to receive the lens, and the back side having at least one back opening for admitting an incident external light beam to the housing;
a first reflector disposed in the housing to reflect the external light beam off the first reflector;
a second reflector disposed in the housing to reflect the external light beam off the second reflector;
an intermediate reflecting module disposed in the housing to reflect the external light beam reflected off the first reflector so that the external light beam falls on the lens or reflect the external light beam reflected off the second reflector so that the external light beam falls on the lens; and
a switcher,
wherein the photo-taking assistant device switches between a first state and a second state by the switcher,
wherein the switcher ensures that substantially the external light beam reaches the lens via the second reflector and the intermediate reflecting module when the photo-taking assistant device is in the first state and that substantially the external light beam reaches the lens via the first reflector and the intermediate reflecting module when the photo-taking assistant device is in the second state.

In a fourth embodiment, a photo-taking assistant device unfastenably mounted on a photo-taking device, the photo-taking device comprising a lens, and the photo-taking assistant device includes:
a housing having a front side and a back side opposing the front side, the front side having a front opening for abutting against the photo-taking device so as to receive the lens, and the back side having at least one back opening for admitting an incident external light beam to the housing;
a first reflector disposed in the housing to reflect the external light beam off the first reflector;
a second reflector disposed in the housing to reflect the external light beam off the second reflector; and
an intermediate reflecting module disposed in the housing to not only reflect the external light beam reflected off the first reflector and thereby allow the external light beam to fall on a first area of the lens but also reflect the external light beam reflected off the second reflector and thereby allow the external light beam to fall on a second area of the lens so that the lens produces images together from the external light beam reflected off the first reflector and the external light beam reflected off the second reflector but the images do not overlap.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

The following description, the appended claims, and the embodiments of the present invention further illustrate the features and advantages of the present invention.

### BRIEF DESCRIPTION OF THE DRAWINGS

FIG. 1 is showing a photo assistant device according to an embodiment of the present invention;

FIG. 2 is showing a photo assistant device according to another embodiment of the present invention;

FIG. 3 is showing a photo assistant device according to another embodiment of the present invention; and

FIG. 4 is showing a photo assistant device according to another embodiment of the present invention.

### DETAILED DESCRIPTION OF THE EMBODIMENTS

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

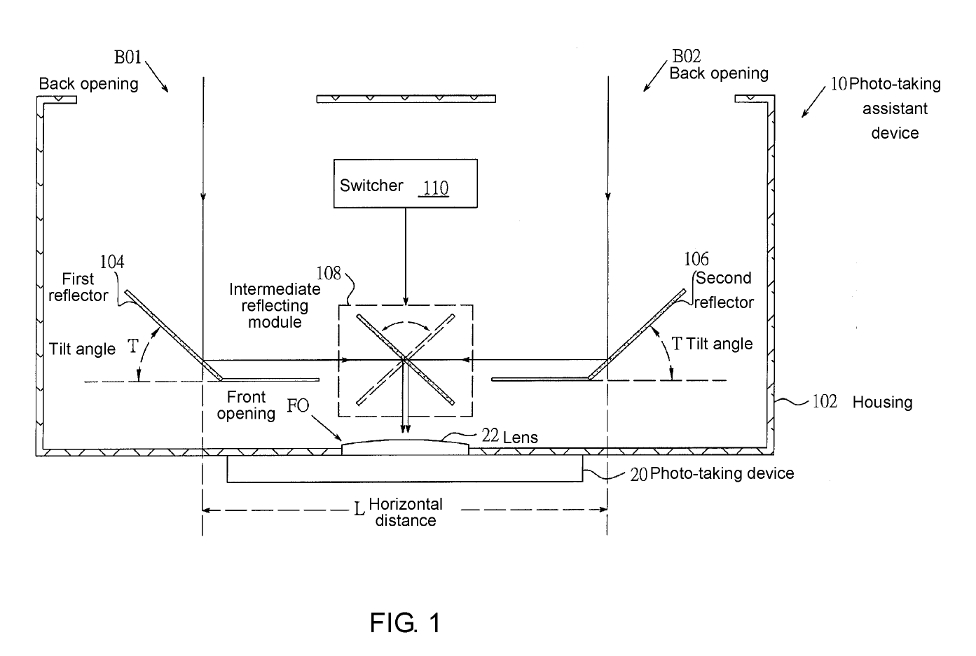

FIG. 1 shows a photo-taking assistant device 10 according to an embodiment of the present invention. The photo-taking assistant device 10 unfastenably mounted on a photo-taking device 20 is, for example, a smartphone equipped with a lens on one side of the smartphone. Moto Z smartphones and and Hasselblad True Zoom camera modules (which serves as an unfastenable assistant device) are good examples for frameworks attributed to the photo-taking assistant device 10 and the photo-taking device 20 but are not directly related to the present invention.

In the embodiment illustrated with FIG. 1, the photo-taking assistant device 10 has a housing 102. The housing 102 has therein a first reflector 104, a second reflector 106, an intermediate reflecting module 108, and a switcher 110.

Referring to FIG. 1, the housing 102 has a front opening FO. When the photo-taking assistant device 10 is mounted on the photo-taking device 20, the front opening FO receives a lens 22 of the photo-taking device 20, and preferably the photo-taking assistant device 10 abuts tightly against the photo-taking device 20 to preclude the arrival of any other light beam from outside the photo-taking assistant device 10 at the lens 22 and light leakage.

The housing 102 further has back openings BO1, BO2 disposed opposite to the front opening FO. The back opening BO1 admits light beams from outside the housing 102 to the housing 102 and thus allows the light beams to fall on the first reflector 104 therein. Then, the first reflector 104 reflects off the incident light beams so that they fall on the intermediate reflecting module 108. The intermediate reflecting module 108 either reflects off the incident light beams or guides them to the lens 22 of the photo-taking device 20 to produce images. Similarly, the back opening BO2 admits light beams from outside the housing 102 to the housing 102 and thus allows the light beams to fall on the second reflector 106 therein. Then, the second reflector 106 reflects off the incident light beams so that they fall on the intermediate reflecting module 108. The intermediate reflecting module 108 either reflects off the incident light beams or guides them to the lens 22 of the photo-taking device 20 to produce images.

In this embodiment, the first reflector 104 and the second reflector 106 are simple reflecting mirrors. The intermediate reflecting module 108 is a reflecting mirror which switches between two tilt angles by the switcher 110 as needed so that the intermediate reflecting module 108 either faces the first reflector 104 but faces away from the second reflector 106 or faces the second reflector 106 but faces away from the first reflector 104. The switcher 110 is operated manually by a user or electrically connected to the photo-taking device 20 so as to be controlled with a user interface on the photo-taking device 20; for its implementation, make reference to the aforesaid Hasselblad True Zoom camera modules.

When the intermediate reflecting module 108 faces the first reflector 104 but faces away from the second reflector 106, both the first reflector 104 and the intermediate reflecting module 108 are preferably arranged in a manner to ensure that the light beam which enters the back opening BO1 and falls on the first reflector 104 is parallel to the light beam which impinges on the lens 22 (that is, the light beam which ultimately falls on the lens 22) after passing the first reflector 104 and reflecting off the intermediate reflecting module 108. Referring to FIG. 1, for instance, the first reflector 104 and the intermediate reflecting module 108 are two reflecting mirrors each oriented at a tilt angle T of 45° to the front opening FO, but the present invention is not restricted to any specific tilt angle T. Understandably, the aforesaid requirement will be fulfilled, provided that the first reflector 104 and the intermediate reflecting module 108, i.e., the reflecting mirrors, are parallel. Furthermore, other optical components are optionally disposed between the first reflector 104 and the intermediate reflecting module 108.

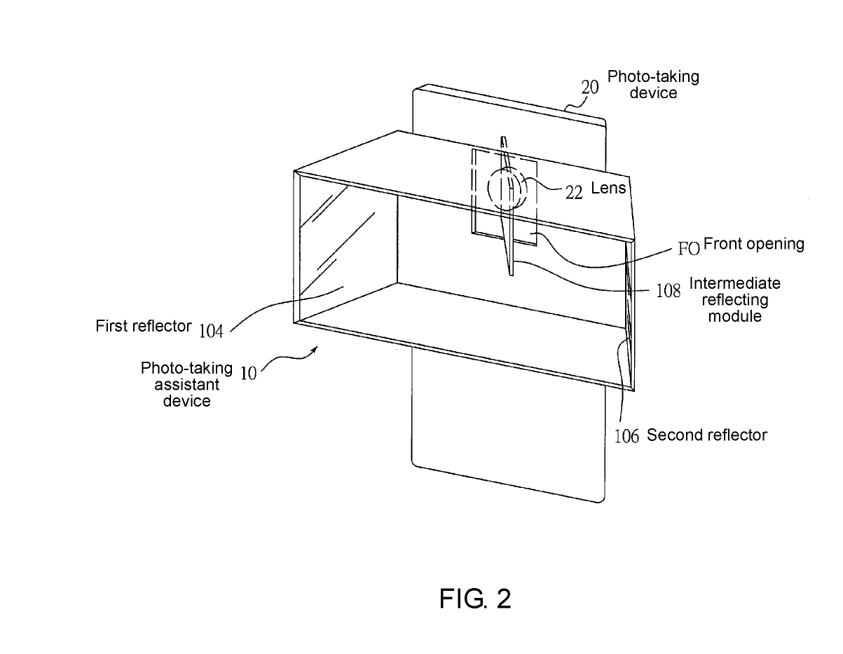

Similarly, when the intermediate reflecting module 108 faces the second reflector 106 but faces away from the first reflector 104, both the second reflector 106 and the intermediate reflecting module 108 are preferably provided to ensure that the light beam which enters the back opening BO2 and falls on the second reflector 106 is parallel to the light beam which impinges on the lens 22 (that is, the light beam which ultimately falls on the lens 22) after passing the second reflector 106 and reflecting off the intermediate reflecting module 108. FIG. 2 is a perspective view of the photo-taking assistant device 10 according to another embodiment of the present invention. Unlike FIG. 1, FIG. 2 does not show all the components of the photo-taking assistant device 10 for illustrative sake.

In the embodiment illustrated with FIG. 1, an external light beam travels from the back opening BO1 via the first reflector 104 and the intermediate reflecting module 108 to the center of the lens 22 for the same optical path length as traveled by another external light beam from the back opening BO2 via the second reflector 106 and the intermediate reflecting module 108 to the center of the lens 22, and the two light paths are symmetric to each other, so as to reduce errors of resultant images to the advantage of 3D photo-taking. The aforesaid technical feature is not necessarily that of the present invention.

In the aforesaid embodiment, by changing its angle of reflection, the intermediate reflecting module 108 reflects off a light beam from the first reflector 104 or reflects off a light beam from the second reflector 106, so as to selectively produce images by two different light paths and thereby simulate “taking photos with two lenses,” thus dispensing with the need for two lenses.

Preferably, the first reflector 104 and the second reflector 106 have mechanical components to ensure that a horizontal distance L between the first reflector 104 and the second reflector 106 is adjustable. Preferably, the horizontal distance between the first reflector 104 and the second reflector 106 is centered at a horizontal point corresponding in position to the lens 22 and thereby is adjustable with respect to the midpoint. Hence, the midpoint of the horizontal distance between the first reflector 104 and the second reflector 106 corresponds in position to the lens 22. The horizontal distance L between the first reflector 104 and the second reflector 106 is adjusted with the switcher 110 operated manually by a user or electrically connected to the photo-taking device 20 so as to be controlled with a user interface on the photo-taking device 20; for its implementation, make reference to the aforesaid Hasselblad True Zoom camera modules.

The horizontal distance L between the first reflector 104 and the second reflector 106 is a key factor in 3D photo-taking and generally corresponds to the distance (around 6.5 cm) between the left eye and the right eye of a human being. However, the distance between the left eye and the right eye varies from person to person. Referring to FIG. 1, the horizontal distance L is calculated preferably with reference to a light beam which falls on the center of the lens 22. In this regard, the horizontal distance is fixed and thus not readily adjustable, as disclosed in the prior art, such as the conventional dual-lens design and US Pub. US20040213560A1. The present invention, as described above, discloses adjusting the horizontal distance readily to meet user needs, for example, within a range of 3˜10 cm, and preferably 4˜7.5 cm, and thus 3D photos taken according to the present invention are pleasant to specific users. Furthermore, there are differences in presumed distances between the two eyes of users and adjustable ranges of the distances between different brands of headworn 3D photo display units, also known as VR display units; hence, the horizontal distance between the first reflector 104 and the second reflector 106 must be adjusted before 3D photos are taken.

To ensure a fan-out visual field, areas of effective reflecting surfaces required for the first reflector 104, second reflector 106, and intermediate reflecting module 108 vary with the horizontal distances among the first reflector 104, second reflector 106, and intermediate reflecting module 108. In this regard, calculation of the areas of effective reflecting surfaces can be carried out by persons skilled in the art with basic geometric optics knowledge and thus is not described herein for the sake of brevity.

In another embodiment, not only is the horizontal distance between the first reflector 104 and the second reflector 106 adjustable, but reflecting surface angles of the first reflector 104, second reflector 106, and intermediate reflecting module 108 are also adjustable. The aforesaid feature is useful in, for example, in attaining a “virtual wide-angle lens” and simulating changes in degrees by which the eyeballs rotate during a 3D photo-taking process, where the sizes of the back openings BO1, BO2 must be large enough to preclude visual field restriction.

Preferably, during the 3D photo-taking process, the photo-taking device 20 must stay stable, for example, by being placed on a table (not shown), mounted on a tripod (not shown), or even mounted on a vibration resistant tripod or deck (not shown). For further details, make reference to SMOVE handheld stabilizers. Understandably, the aforesaid feature is not necessarily that of the present invention.

### Variant Embodiment 1

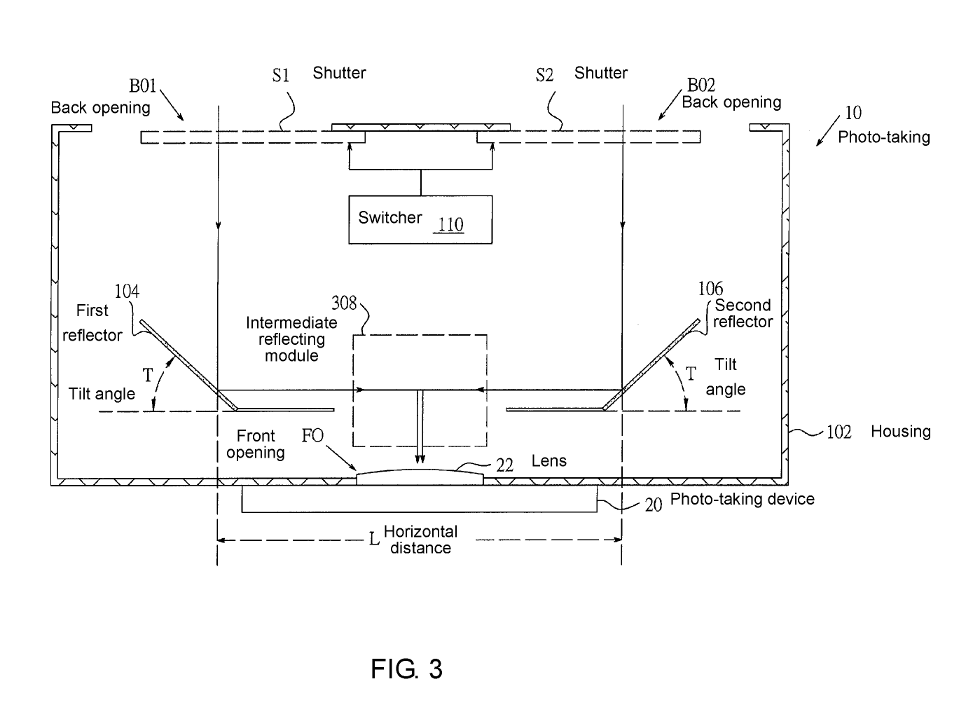

In the embodiment illustrated with FIG. 1, light beams incident onto the lens 22 are changed by adjusting the intermediate reflecting module 108. By contrast, in the embodiment illustrated with FIG. 3, the intermediate reflecting module 308 (shown schematically) is unadjustable and is a combiner for guiding light beams from the first reflector 104 and the second reflector 106 to the lens 22 simultaneously, though positions, shapes, and areas of reflecting surfaces of the first reflector 104 and the second reflector 106 must be adjusted and thus differ from those in FIG. 1. All these, however, can be attained with reference to simple knowledge of optical design and thus are not described herein for the sake of brevity.

In this embodiment, to prevent images produced on two different light paths from overlapping, it is necessary to block one of the light paths. In the embodiment illustrated with FIG. 3, the back openings BO1, BO2 can be opened and closed to allow the back opening BO1 to be opened by the switcher 110 and allow the back opening BO2 to be closed by a shutter S2, so as to ensure that only the light beams admitted by the back opening BO1 can fall on the lens 22 via the first reflector 104 and the intermediate reflecting module, whereas the back openings BO1, BO2 can be opened and closed to allow the back opening BO2 to be opened by the switcher 110 and allow the back opening BO1 to be closed by a shutter S1, so as to ensure that only the light beams admitted by the back opening BO2 can fall on the lens 22 via the second reflector 106 and the intermediate reflecting module 308. The aforesaid feature is also useful in producing the effect of changing the angle of the intermediate reflecting module 108 as disclosed in the embodiment illustrated with FIG. 1.

Not only are light paths selectively closed by opening and closing the back openings BO1, BO2, but a movable shutter (not shown) is also placed at any point on the light paths between the lens 22 and the back openings BO1, BO2. Hence, the switcher 110 enables a shutter to be placed on the light path between the back opening BO2 and the lens 22 to ensure that only the light beams admitted by the back opening BO1 can fall on the lens 22 via the first reflector 104 and the intermediate reflecting module. Conversely, the switcher 110 enables a shutter to be placed on the light path between the back opening BO1 and the lens 22 to ensure that only the light beams admitted by the back opening BO2 can fall on the lens 22 via the second reflector 106 and the intermediate reflecting module 308. The aforesaid feature is also useful in producing the effect of changing the angle of the intermediate reflecting module 108 as disclosed in the embodiment illustrated with FIG. 1.

### Variant Embodiment 2

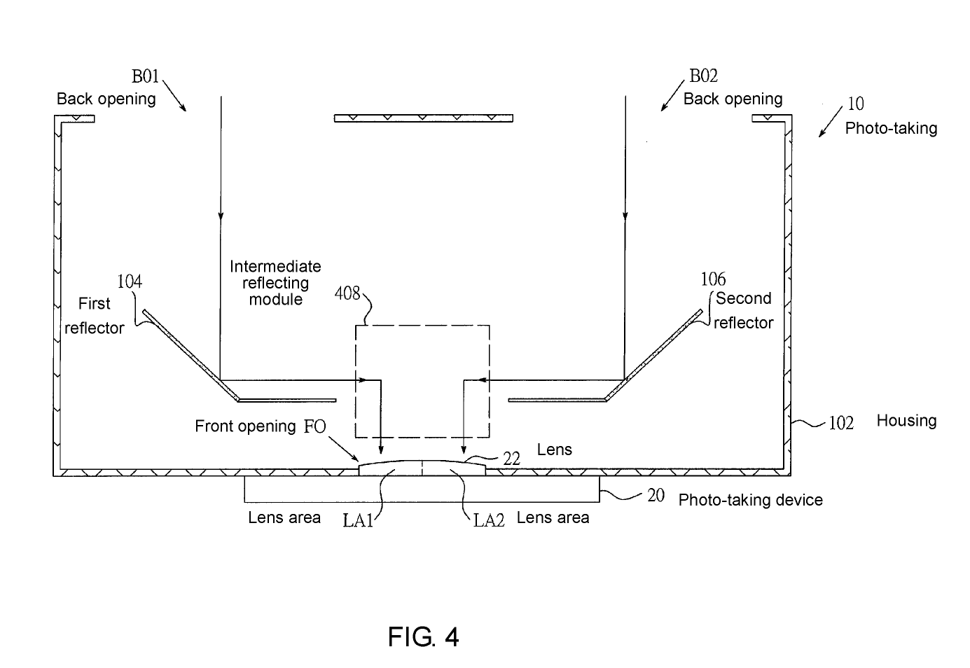

In the embodiment illustrated with FIG. 3, to prevent images produced on two different light paths from overlapping, it is necessary to close one of the light paths. By contrast, in the embodiment illustrated with FIG. 4, light beams admitted from the back openings BO1, BO2 are allowed to fall on the lens 22 simultaneously. In this embodiment, to prevent the images thus produced from overlapping, the two light paths are configured to ensure that images produced on the two light paths fall on different areas of the lens 22 and thus are formed at different positions on the lens 22, thereby preventing the images from overlapping. Referring to FIG. 4, light beams admitted by the back opening BO1 fall on an area LA1 of the lens 22 via the first reflector 104 and the intermediate reflecting module 408, whereas light beams admitted by the back opening BO2 fall on an area LA2 of the lens 22 via the second reflector 106 and the intermediate reflecting module. Therefore, light beams admitted by the back openings BO1, BO2 form images concurrently through the lens 22. The light beams admitted by the back opening BO1 form images through the area LA1 of the lens 22, whereas the light beams admitted by the back opening BO2 form images through the area LA2 of the lens 22. Afterward, the images are process by computer software to separate each image associated with the back opening BO1 and each image associated with the back opening BO2, wherein all the images are formed by means of the lens 22. Finally, 3D images are produced. Understandably, although the aforesaid technique ends up with an image resolution lower than the one achieved by the embodiment illustrated with FIG. 3, it dispenses with the shutters shown in FIG. 3.

Unlike the embodiment illustrated with FIG. 3, the embodiment illustrated with FIG. 4 is characterized by making changes and adjustments to the first reflector 104, second reflector 106, and intermediate reflecting module 408 or placing other optical components (for example, lenses (not shown)) on the light paths to ensure that light beams which are admitted by the back openings BO1, BO2 and then fall on the lens 22 to have smaller light beam dimensions, and thus the light beams can fall on the areas LA1, LA2 on the lens 22 simultaneously. The aforesaid feature can be effectuated with reference to simple knowledge of optical design and thus is not described herein for the sake of brevity. Preferably, the ultimately formed images do not overlap, but a slight overlap is permitted to happen to the areas LA1, LA2 on the lens 22, which can be achieved by controlling the angle at which the light beams are incident on the lens 22.

The present invention can be embodied in any other specific manners without departing from the spirit or essential features of the present invention. Every aspect of the aforesaid embodiments of the present invention must be deemed illustrative rather than restrictive of the present invention. Hence, the scope of the present invention is defined by the appended claims instead of the above description. All equivalent meanings and scope which fall within the appended claims must be deemed falling within the scope of the appended claims.

What is claimed is:

1. A photo-taking assistant device unfastenably mounted on a photo-taking device, the photo-taking device comprising a lens, and the photo-taking assistant device comprising:
a housing having a front side and a back side opposing the front side, the front side having a front opening for abutting against the photo-taking device so as to receive the lens, and the back side having at least one back opening for admitting an incident external light beam to the housing;
a first reflector disposed in the housing to reflect the external light beam off the first reflector;
a second reflector disposed in the housing to reflect the external light beam off the second reflector;
an intermediate reflecting module disposed in the housing to reflect the external light beam reflected off the first reflector so that the external light beam falls on the lens or reflect the external light beam reflected off the second reflector so that the external light beam falls on the lens; and
a switcher,
wherein the photo-taking assistant device switches between a first state and a second state by the switcher,
wherein the switcher ensures that substantially no external light beam reaches the lens via the first reflector and the intermediate reflecting module when the photo-taking assistant device is in the first state and that substantially no external light beam reaches the lens via the second reflector and the intermediate reflecting module when the photo-taking assistant device is in the second state.

2. The photo-taking assistant device of claim 1, wherein the intermediate reflecting module has a rotatable reflecting surface, and the switcher ensures that the reflecting surface of the intermediate reflecting module faces the second reflector but faces away from the first reflector when the photo-taking assistant device is in the first state and that the reflecting surface of the intermediate reflecting module faces the first reflector but faces away from the second reflector when the photo-taking assistant device is in the second state.

3. The photo-taking assistant device of claim 1, wherein the back side has a first back opening and a second back opening, the first back opening admitting the external light beam so as for the external light beam to fall on the first reflector, the second back opening admitting the external light beam so as for the external light beam to fall on the second reflector, and the switcher enabling the first back opening to close and the second back opening to open when the photo-taking assistant device is in the first state and enabling the second back opening to close and the first back opening to open when the photo-taking assistant device is in the second state.

4. The photo-taking assistant device of claim 1, further comprising a first shutter and a second shutter, with the back side having a first back opening and a second back opening, the first back opening admitting the external light beam so as for the external light beam to fall on the first reflector, the second back opening admitting the external light beam so as for the external light beam to fall on the second reflector, and the switcher enabling the first shutter to be placed on a light path between the first back opening and the lens when the photo-taking assistant device is in the first state and enabling the second shutter to be placed on a light path between the second back opening and the lens when the photo-taking assistant device is in the second state.

5. The photo-taking assistant device of claim 1, wherein the back side has a first back opening and a second back opening, the first back opening admitting the external light beam so as for the external light beam to fall on the first reflector, and the second back opening admitting the external light beam so as for the external light beam to fall on the second reflector, wherein the external light beam travels from the first back opening via the first reflector and the intermediate reflecting module to the lens for a same optical path length as traveled by the external light beam from the second back opening via the second reflector and the intermediate reflecting module to the lens.

6. The photo-taking assistant device of claim 5, wherein the first reflector and the intermediate reflecting module are arranged to ensure that the external light beam which falls on the first reflector is parallel to the external light beam which impinges on the lens after passing the first reflector and reflecting off the intermediate reflecting module.

7. The photo-taking assistant device of claim 6, wherein the second reflector and the intermediate reflecting module are arranged to ensure that the external light beam which falls on the second reflector is parallel to the external light beam which impinges on the lens after passing the second reflector and reflecting off the intermediate reflecting module.

8. The photo-taking assistant device of claim 7, wherein a horizontal distance between the first reflector and the second reflector is adjustable.

9. The photo-taking assistant device of claim 8, wherein the horizontal distance between the first reflector and the second reflector is centered at a horizontal point corresponding in position to the lens and thereby is adjustable.

10. A photo-taking assistant device unfastenably mounted on a photo-taking device, the photo-taking device comprising a lens, the photo-taking assistant device comprising:
a housing having a front side and a back side opposing the front side, the front side having a front opening for abutting against the photo-taking device so as to receive the lens, and the back side having at least one back opening for admitting an incident external light beam to the housing;
a first reflector disposed in the housing to reflect the external light beam off the first reflector;
an intermediate reflecting module disposed in the housing to reflect the external light beam reflected off the first reflector so that the external light beam falls on the lens; and
a switcher,
wherein the photo-taking assistant device switches between a first state and a second state by the switcher,
wherein the switcher ensures that substantially no external light beam reaches the lens via the first reflector and the intermediate reflecting module when the photo-taking assistant device is in the first state and that substantially the external light beam reaches the lens via the first reflector and the intermediate reflecting module when the photo-taking assistant device is in the second state.

11. A photo-taking assistant device unfastenably mounted on a photo-taking device, the photo-taking device comprising a lens, the photo-taking assistant device comprising:
a housing having a front side and a back side opposing the front side, the front side having a front opening for abutting against the photo-taking device so as to receive the lens, and the back side having at least one back opening for admitting an incident external light beam to the housing;
a first reflector disposed in the housing to reflect the external light beam off the first reflector;
a second reflector disposed in the housing to reflect the external light beam off the second reflector;
an intermediate reflecting module disposed in the housing to reflect the external light beam reflected off the first reflector so that the external light beam falls on the lens or reflect the external light beam reflected off the second reflector so that the external light beam falls on the lens; and
a switcher,
wherein the photo-taking assistant device switches between a first state and a second state by the switcher,
wherein the switcher ensures that substantially the external light beam reaches the lens via the second reflector and the intermediate reflecting module when the photo-taking assistant device is in the first state and that substantially the external light beam reaches the lens via the first reflector and the intermediate reflecting module when the photo-taking assistant device is in the second state.
